(19) United States
(12) Patent Application Publication
(10) Pub. No.: US 2025/0194579 A1
(43) Pub. Date: Jun. 19, 2025

(54) CLOSED TRANSFER SYSTEM FOR HERBICIDE APPLICATION

(71) Applicant: VP Environmental, LLC, Friendship, ME (US)

(72) Inventor: Douglas VanderPloeg, Friendship, ME (US)

(21) Appl. No.: 18/544,350

(22) Filed: Dec. 18, 2023

(51) Int. Cl. A01M 21/04

(52) U.S. Cl. CPC A01M 21/043

(57) ABSTRACT

A closed herbicide application system and method of using the system. The system is an attachable system placed on the roots or stumps of plants to apply herbicide in an efficient manner. The system is attached to a plant stump wherein the system applies a herbicide directly to the stump and root system. The system also has characteristics to provide a quick and easy method of identifying where treatment has been applied.

### BACKGROUND OF THE INVENTION

### 1. Field of the Invention

The present invention relates to a herbicide application system and related method. More specifically, the present invention relates to a closed application system which is attached to a plant and delivers a herbicide. Still more specifically, the present invention relates to a herbicide application system, which targets a single plant or vine and minimizes adjacent plant, wildlife, and environmental exposure to such herbicide.

### 2. Description of the Prior Art

There currently exists methods of stopping, killing, or otherwise removing the spread of unwanted or invasive trees, bushes, weeds, or other types of plant growth. Invasive or unwanted plant growth is a state, national, and worldwide challenge. Invasive or unwanted plant growth can have significant negative impacts that may include soil erosion, degradation of water quality for other plants, making water ways impenetrable, degradation of soil quality, smother, displace, or kill surrounding native species, displace wildlife, increase competition for resources, require significant annual manual labor dedication as well as many other negative impacts. Invasive plant species typically have characteristics which make stopping or preventing spread difficult. Some of these characteristics are aggressive root systems, excessive seed production, or chemical production which kills or negatively affects other growth.

Some methods of preventing or stopping invasive plant growth include mechanical means, suffocation, cutting or mowing, foliar spray (herbicide application) general and multiple target controls, and cut stem treatment. Most of these methods include challenges such as manual labor requirements, need for annual due diligence, risk of spreading seeds, failing to permanently kill the plant, improper or ineffective application of herbicides, potential harm to humans including those carrying out the application, wildlife, pets, and contamination of water supply. These methods may also vary depending on the type of plant which is being targeted. For example, some plants may have a vast number of stems or individual plants where it is not feasible to cut each stem. Other plants may be resistant to certain types of herbicides. Still further, some species become too large or have such a widespread root system that they are unable to be removed or pulled out.

One method of preventing the spread of invasive species is a method wherein a plant is cut at the stem to form a stump (cut stem). The stump is then treated with a herbicide to kill the root system and prevent regrowth. A dye, paint, or other method of marking is then applied to the stump to mark the treated plant. This treatment is typically performed on plants of varying sizes where removal is an inefficient or impossible prevention method. Removal of the plant from the roots prevents the roots from obtaining the nutrients required from photosynthesis. The application of the herbicide is designed to kill the roots and prevent or limit regrowth. Marking the treatment with a dye or paint helps to limit repetitive manual work and indicate where work has been completed. Typically, this process is referred to as the “cut and brush” technique.

The “cut and brush” technique is typically performed with a saw, clippers, or other such method of removing the plant from the stem. A herbicide is then selected and applied to the cut stump. The application may be done with a spray bottle, brush, or backpack sprayer. Once the herbicide has been applied, the user then marks the treated plant by painting or marking the stump with a noticeable color. The method is widely recommended and used to control woody plants or vines, which typically have a single or limited number of stems or trunks. The technique requires the user to perform several tasks to complete the treatment of one stem or trunk. The process may be time-consuming and require significant manual labor to perform. It is not economically feasible at scale. Moreover, the application can be hazardous. The herbicide can contaminate the laborers, be washed off from rain, fog, snow, or blown off from the wind.

What is needed is a closed system and method of treatment which reduces exposure, focuses herbicide application and minimizes labor requirements during the herbicide application. What is also needed is a system and method which allows a user to easily apply a herbicide to a targeted stump or stem or cluster of stumps or stems while simultaneously marking the treated stump or stem. Currently, the user is required to first cut the plant, retrieve and use the herbicide applicator, and then mark the site to notify that the stump or stem has been treated. This method requires the user to prepare, carry, and move all materials required to cut, treat, and mark each plant treated. What is needed is a more efficient and economically feasible system and method of applying herbicide and marking the treated plant.

### SUMMARY OF THE INVENTION

The present invention is a closed herbicide application system and related method. It is a goal of the present invention to provide a safe, more efficient, effective, and economically feasible herbicide application system. The system provides the user with a more efficient method of applying a herbicide and marking the treated plant. The herbicide application system has a retainer which contains the desired amount and type of herbicide. The desired amount may be pre-measured and retained in the retainer or may be selectively adjusted at the time of application. The retainer has a method of attachment to secure the system to the desired target. The system is attached to a cut branch, stem, trunk, or stump, or cluster thereof.

It is a goal of the system to provide a single, easy application of herbicide, which simultaneously, in a single step, identifies a plant that has been treated. The system is configured to enable a user to apply a selective or predetermined amount and type of herbicide quickly and accurately with a single action and without being required to switch between multiple systems or apparatuses to achieve the same effect. It is a further goal of the present system to efficiently use an appropriate amount of herbicide without waste or application to the surrounding environment.

The retainer may hold various types and amounts of herbicide. In an embodiment, the present invention is designed to hold and transfer herbicide. The amount of herbicide is previously determined by the user, manufacturer, or other party and held in the retainer until the system is in use. The user, manufacturer, or other party may anticipate the amount and type of herbicide needed to properly treat a certain species or size of plant or tree. Additionally, the retainer may be formed of various diameters or sizes to accommodate a variety of sizes of stumps or plants. For example, some stumps or cut stems may be about 5 to 10 millimeters (about 0.20-0.40 inches) while others may be about 75 to 100 millimeters (about 3 to 4 inches) or larger. The retainer may be of varying sizes to accommodate various sized cut stems as well as various amounts of herbicide. The retainer contains a selected amount of herbicide, wherein the retainer holds the herbicide until the system is placed on a stump or stem. The retainer then releases the herbicide to the plant through the delivery component.

The delivery component of the present invention allows for the herbicide within the retainer to be disbursed to the target plant. The delivery component may seal and retain the herbicide while the system is being transported to the target. Once the system is engaged with the target, the delivery component releases the herbicide, thereby treating the plant. The delivery component may have a selective amount of herbicide release, designed such that the system may be applied to the target, which will receive a specific amount of herbicide treatment over a certain amount of time. The delivery component may be configured to release the herbicide to the target plant at various rates, as desired by the user.

The system has a securing component which facilitates attachment of the system to a target plant. The securing component is used to attach and hold the system in place to facilitate the transfer of herbicide to the target plant. The securing component may be a strap, rope, threading component, spike, flexible crimping material, cinching method, tape, glue, rubber band or other method of attachment. The system is placed on to a cut stump such that the herbicide may be applied to the cut area. The strap, which is coupled to the system, is then wrapped around the stump and secured to hold the system in place. In another embodiment, the securing component is a threaded feature, in which the system is placed on the stump and twisted to secure the system in place on the stump. In yet another embodiment, the securing component is one or more spikes or barbs which are driven into the stump or surrounding area to secure the system in place on the stump. In yet another embodiment, the retainer may be made of a bendable material such as an aluminum foil, metal, or other such material. The retainer may be formed, reformed, wrapped, or crimped to adhere the device to the stump.

The system has an identification component, which allows a user or other individual to easily notice the system when in use. The identification component serves as a marker to allow for quick and easy identification of treated plants so that the user can quickly identify treated from untreated plants. The identification component may be configured as an attachment, such as a flag, tag, or other item. Alternatively, the identification component may be a colored plastic of which the retainer is made. Still further, the identification component may be a colored paint applied to the system. It is a goal of this aspect of the system to provide quick and easy identification of which plants have been treated, such that the user and other observers may assess and identify other areas or plants in need of treatment.

In an embodiment of the present invention, the retainer is a pouch, pocket, or fiber which retains a set amount of herbicide. The delivery component is a cap which may be made from various materials, such as a plastic, material, composite, rubber, or other material which secures the herbicide in the retainer. In some embodiments, the material may be a porous material which controls the speed at which the herbicide is applied to the target. In an embodiment, the identification component is a bright color or shiny material to identify the retainer. The retainer may be formed with a dye or coloring or may be painted. Typically, the color of the retainer is a bright color or shiny material, not typically found in the environment of the target plants, such that the system may be easily and clearly identified. Still further, in an embodiment, some or all components of the system is made of biodegradable material.

### BRIEF DESCRIPTION OF THE DRAWINGS

FIG. 1 is a top perspective view of the herbicide application device of the present invention.

FIG. 2 is a front cross-sectional view of the present invention engaged with a plant stem or stump.

FIG. 3 is a front perspective view of the present invention showing the securing component.

FIG. 4 is a front view of a second embodiment of the present invention.

FIG. 5 is a top perspective view of a second embodiment of the present invention.

FIG. 6 is a front perspective view of a second embodiment of the present invention.

### DETAILED DESCRIPTION OF THE INVENTION

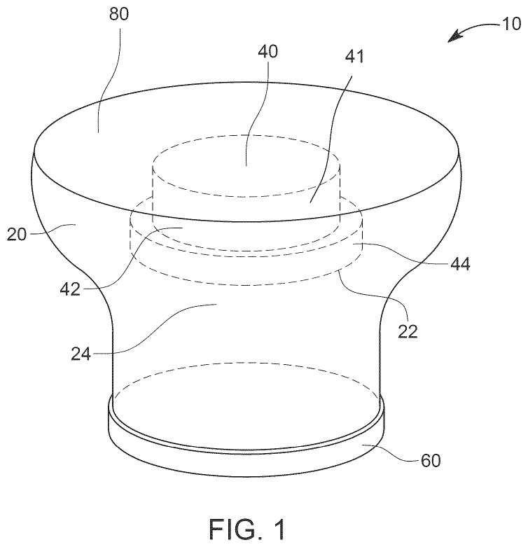

A first embodiment of a herbicide application system 10 of the present invention is shown in FIGS. 1-3. The system 10 has a retainer 20, a delivery component 40, a securing component 60, and an identification component 80. The retainer 20 has an inner space 22 and an opening 24. The delivery component 40 has a conduit 42, an optional cap 44, and optional porous covering 46. The securing component 60 has a first end 62 and a second end 64.

The retainer 20 is a pouch, pocket, or other such container which may hold a herbicide. Typically, the herbicide is in a liquid form. The herbicide is stored in the inner space 22 of the retainer 20 until the system 10 is coupled to a target plant stump 100. Once the system 10 is coupled to the plant stump or stem 100, the herbicide may exit the inner space 22 through the opening 24 of the retainer 20 to be applied to the stump 100.

The delivery component 40 is coupled to the retainer 20 and provides a mechanism to transport the herbicide from the inner space 22 of the retainer 20 to the stump 100. The conduit 42 of the delivery component 40 may be in contact with the stump 100. The delivery component 40 may have an optional cap 44, an optional porous covering 46, or both. The cap 44 serves as an element for keeping the herbicide in the retainer 20 until the system 10 is applied to the stump 100. The porous covering 46 serves as an element for controlling the application speed of the herbicide to the stump 100.

The securing component 60 provides a mechanism for attaching the system 10 to the stump 100. The securing component 60 has a first end 62 which is permanently coupled to the system 10. The second end 64 of the securing component 60 is designed to engage with the stump 100 to secure the system 10 in a position where the herbicide may be applied to the stump 100. The second end 64 may be formed as a spike, barb, screw, threading, or crimping, or other method of attachment. Alternatively, the second end 64 may be a flexible attachment method such as a rope, strap, or other method wherein the system 10 may be attached to the stump 100.

The identification component 80 is a mechanism for the user to identify plants in areas and locations that have been treated using the system 10 of the present invention. The identification component 80 may be colored paint, dye, shiny material, or other form of distinguishing the system 10 from the surrounding environment. The identification component 80 may also be a flag, ribbon, or other label coupled to the system 10 to identify that the system 10 is in use with a stump 100.

As depicted in FIG. 1, the system 10 may be quickly and easily secured to the target stump 100. The system 10 is designed to be carried by a user such that when a plant has been cut, the system 10 will be easily applied to the exposed surface area of the recently cut stump 100. The user may carry a saw, chainsaw, clippers, or other method of severing the plant to expose the stump 100 while also carrying the system 10, allowing the system 10 to be secured to the stump 100 immediately after the cut. The system 10 is oriented such that the herbicide is delivered from the delivery component 40 to the stump or cut stem 100. The delivery component 40 may be in direct contact with the cut end of the stump 100 such that the herbicide is delivered to the stump 100 and into the root system.

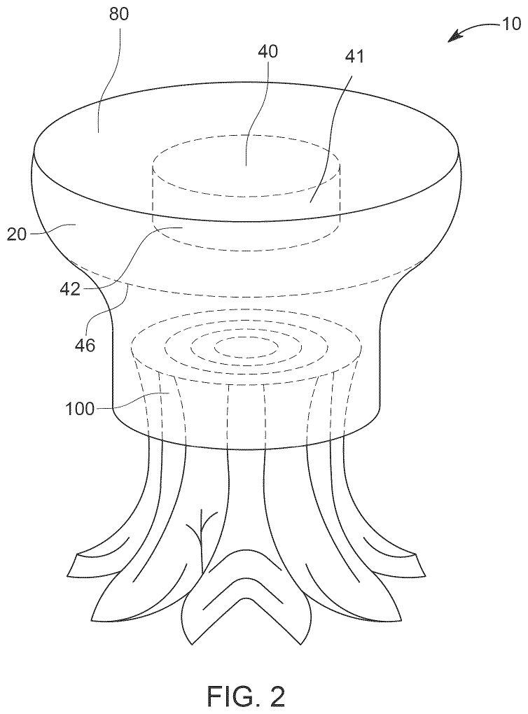

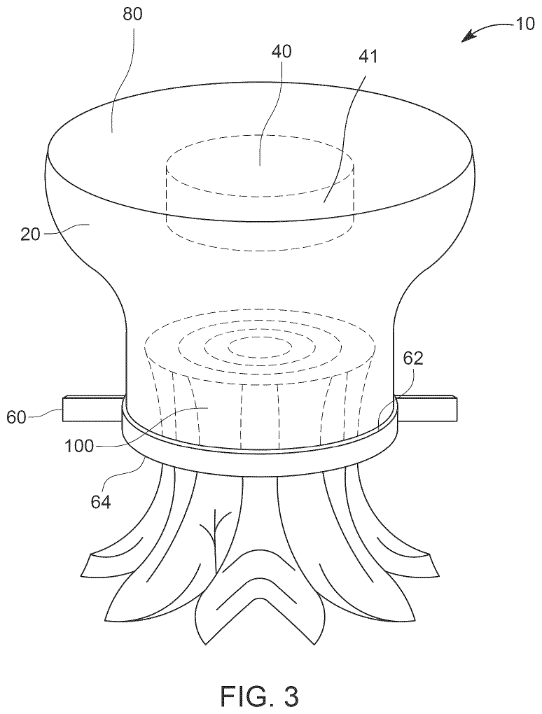

As depicted in FIGS. 2 and 3, the system 10 is placed on or over the stump 100 and secured in place. The system 10 may be designed to fit around a cut stump 100. The retainer 20 may be formed with a material equipped to be bent, wrapped, or otherwise situated above and around the stump 100. The system 10 is retained on the stump 100 to maintain contact with the delivery component 40 and the cut end of the stump 100 such that the herbicide diffuses into the plant and root system. The securing component 60, as depicted in FIG. 3, secures the system 10 to the stump 100. The securing component 60 may be a rope, strap, tape, glue or other method of securing the flexible material of the system 10 to the stump 100. Alternatively, the securing component 60 may be an inherent feature of the material of the retainer 20. For example, the retainer 20 may be made of a flexible aluminum material or other composite. The aluminum material may be bent and wrapped around the stump 100 and hold the form to secure the system 10 in place.

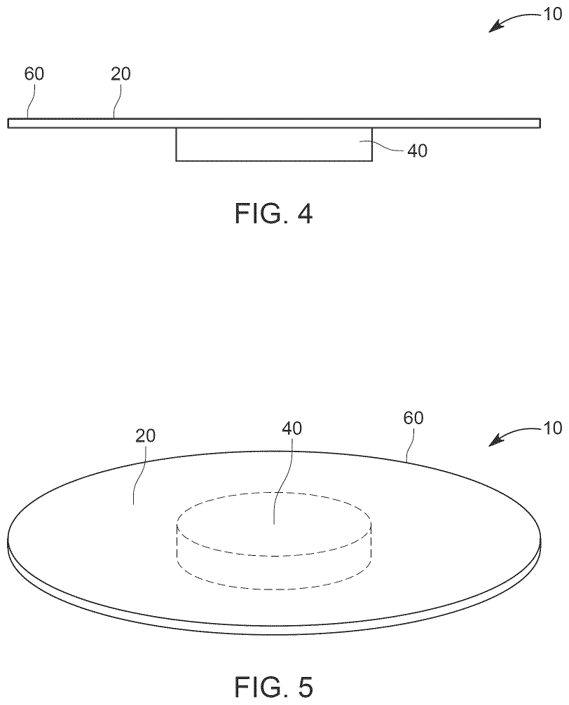

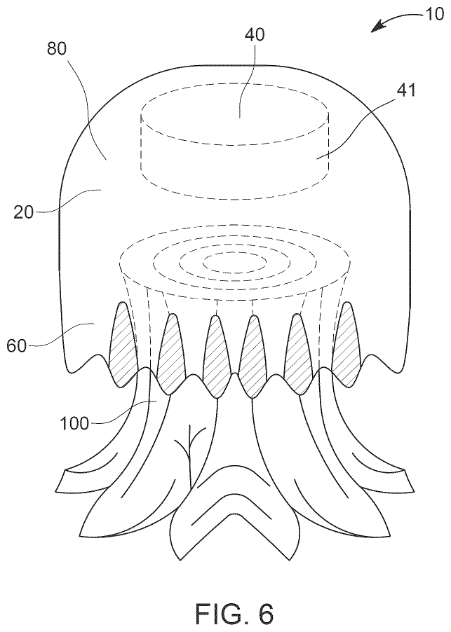

As depicted in FIGS. 4-6, a second embodiment of the system 10 may be formed with the retainer 20 made of a flexible material. The delivery component 40 is attached to the retainer 20. The user may place the device 10 on the stump 100, orienting the delivery component 40 on the cut surface of the stump 100. The flexible material of the retainer 20 may then be formed to match the shape of the stump 100 and secured in place therein. The securing component 60 may be a rope, strap, tape, glue or other method of securing the device 10 in place. Alternatively, the securing component 60 may be an inherent feature of the material of the retainer 20, as depicted in FIGS. 3-6. For example, the retainer 20 may be made of a flexible aluminum material. As further depicted in FIG. 6, the aluminum material may be bent or wrapped around the stump 100 to hold the form of said stump 100 to secure the system 10 in place.

The retainer 20 may alternatively be a pouch, pocket, or hydrophilic material, or other flexible material used to retain the herbicide. Alternatively, the retainer 20 may be a solid structure such as a plastic, metal, or other firm structure wherein the delivery component 40 may be a hydrophilic material used to hold the herbicide. In yet another embodiment, the retainer 20, the delivery component 40, the securing component 60, or the identification component 80 may be made of a biodegradable material.

The present invention has been described with reference to specific examples and configurations. The description is not to be taken in a limiting sense but is made merely for the purpose of illustrating the general principles of the invention, since the scope of the invention is best defined by the appended claims.

1. A herbicide application system for treating an exposed surface of a cut plant, the system comprising:
a retainer;
a delivery component;
a securing component; and
an identification component;
wherein the retainer holds a selected amount of herbicide material within the retainer during transportation and application without exposing a user to the herbicide material;
wherein the delivery component dispenses the herbicide material at a selectable rate from the retainer to the exposed surface; and
wherein the securing component retains the retainer on the cut plant and the identification component, which is coupled to the retainer, identifies placement of the retainer on the cut plant.

2. The device of claim 1 wherein the retainer is selected from the group consisting of a pouch, a container, or a hydrophilic material.

3. The device of claim 1 wherein the delivery component is a channel, a conduit, a tube, or a folded material to form an intermediary between the retainer and the cut plant to deliver the herbicide to the plant.

4. The device of claim 1 wherein the securing component is a spike, a barb, a crimp, or a sharp object to secure the system to the plant.

5. The device of claim 1 wherein the securing component is threaded such that it may be screwed onto the plant.

6. The device of claim 1 wherein the securing component is a cinch, a strap, a crimp, tape, or glue.

7. The device of claim 1 wherein the identification component is a selected color of the retainer.

8. The device of claim 1 wherein the cut plant is a stump of a tree, a stump of a bush, a stump of a vine, or a stump of a weed.
